(19) United States
(12) Patent Application Publication
(10) Pub. No.: US 2024/0038524 A1
(43) Pub. Date: Feb. 1, 2024

(54) MASS SPECTROMETER AND MASS SPECTROMETRY METHOD

(71) Applicant: HITACHI, LTD., Tokyo (JP)

(72) Inventors: Masuyuki SUGIYAMA, Tokyo (JP); Shun KUMANO, Tokyo (JP); Akihiro NOJIMA, Tokyo (JP)

(21) Appl. No.: 18/213,974

(22) Filed: Jun. 26, 2023

(30) Foreign Application Priority Data
Jul. 26, 2022 (JP) 2022-118414

(51) Int. Cl. H01J 49/42; H01J 49/06; H01J 49/00

(52) U.S. Cl. CPC H01J 49/4225; H01J 49/065; H01J 49/429; H01J 49/0031

(57) ABSTRACT

The present disclosure proposes a mass spectrometer including a linear ion trap section and an analyzer that analyzes the ions ejected from the linear ion trap section having a multipole rod electrode including a plurality of segments arranged in a direction of a center axis of the linear ion trap section. A first radio frequency voltage in opposite phase is applied to adjacent rod electrodes. An electrostatic voltage having the same amplitude and a second radio frequency voltage are applied to the segments having the same position in the direction of the center axis. The electrostatic voltage is applied to the segments such that the electrostatic voltage decreases from an inlet to an outlet of the linear ion trap section. The second radio frequency voltage is applied to the segments such that the second radio frequency voltage increases from the inlet to the outlet of the linear ion trap section.

### CROSS-REFERENCE TO RELATED APPLICATION

The present application claims priority from Japanese application JP2022-118414, filed on Jul. 26, 2022, the content of which is hereby incorporated by reference into this application.

### BACKGROUND OF THE INVENTION

### 1. Field of the Invention

The present disclosure relates to a mass spectrometer and a mass spectrometry method.

### 2. Description of the Related Art

An ion trap widely used is a mass spectrometer that accumulates ions and then ejects the ions mass selectively. The configuration and measurement method of the ion trap are described in, for example, U.S. Pat. Nos. 7,456,388 and 7,820,961. U.S. Pat. No. 7,456,388 discloses that a barrier of a pseudo potential is generated at an end portion of a linear ion trap to eject ions mass selectively. In addition, U.S. Pat. No. 7,820,961 discloses that a mass dependent potential is formed in the axial direction of a rod and ions are ejected mass selectively from the vicinity of a minimum point of the potential, the mass dependent potential being formed by applying electrostatic voltage and RF voltage to an insertion electrode inserted in rod electrodes of a linear ion trap.

### SUMMARY OF THE INVENTION

However, in the ion trap disclosed in U.S. Pat. No. 7,456,388, ions are concentrated in the vicinity of the barrier of the pseudo potential, and thus, the ions are easily affected by space charge. In the ion trap disclosed in U.S. Pat. No. 7,820,961, both AC voltage and electrostatic voltage which form a potential in the axial direction of the rod are affected by the shape of the electrode which forms a potential in the axial direction of the rod. Thus, potential minimum points of ions of different m/z are close to each other, and are easily affected by space charge. In the case of being affected by space charge, a disadvantage occurs such that the position of the mass number on the mass spectrum is shifted when ions are ejected mass selectively.

In view of such a situation, the present disclosure proposes a technique in which ions are mass selectively ejected without being affected by space charge.

In order to solve the above problems, the present disclosure proposes, as an example, a mass spectrometer including: a linear ion trap section that traps ions emitted from an ion source; and an analyzer that analyzes the ions ejected from the linear ion trap section, in which the linear ion trap section includes a multipole rod electrode that forms a multipole electric field, the multipole rod electrode including a plurality of segments arranged in a direction of a center axis of the linear ion trap section, in the multipole rod electrode, a first radio frequency voltage in opposite phase is applied to adjacent rod electrodes, an electrostatic voltage having a same amplitude and a second radio frequency voltage are applied to the segments having a same position in the direction of the center axis, the second radio frequency voltage being different from the first radio frequency voltage and being in phase, the electrostatic voltage is applied to the plurality of segments such that the electrostatic voltage decreases from an inlet to an outlet of the linear ion trap section, and the second radio frequency voltage is applied to the plurality of segments such that the second radio frequency voltage increases from the inlet to the outlet of the linear ion trap section.

Additional characteristics related to the present disclosure will be apparent from the description of the present specification and the attached drawings. Aspects of the present disclosure are achieved and realized by elements, combinations of various elements, and aspects of the following detailed description, and the appended scope of claims. Note that the description herein is merely exemplary and does not limit the scope of claims or application examples of the present disclosure in any sense.

According to the technique of the present disclosure, ions can be mass selectively ejected without being affected by space charge.

### BRIEF DESCRIPTION OF THE DRAWINGS

FIG. 1 is a view illustrating a configuration example of a mass spectrometer which uses a linear ion trap according to the present embodiment;

FIG. 2A is a schematic view of appearance of a linear ion trap section (multipole rod electrode);

FIG. 2B is a view illustrating a configuration example of a radial cross section of the linear ion trap section (multipole rod electrode);

FIG. 2C is a view illustrating a configuration example of a radial cross section of the linear ion trap section in the axial direction;

FIG. 3 is a diagram showing a potential formed on the center axis by segment DC voltage;

FIG. 4 is a graph showing a pseudo potential formed on the center axis when RF2 voltage of equation (2) is applied;

FIG. 5 is a diagram showing a potential formed by combining the potential of segment DC in FIG. 3 with the pseudo potential of RF2 in FIG. 4;

FIG. 6A is a diagram showing a sequence when ions are accumulated and cooled, and RF2 is scanned (changed) to eject the ions;

FIG. 6B is a diagram showing a sequence when ions are accumulated and cooled, and segment DC voltage is scanned (changed) to eject the ions;

FIG. 7 is a diagram showing a potential of ions of m/z 200 when an amplitude of RF2 is scanned from 74 V to 22 V; and

FIG. 8 is a view illustrating a configuration example of a radial cross section of a linear ion trap section according to a modified example.

### DESCRIPTION OF THE PREFERRED EMBODIMENTS

Hereinafter, embodiments of the present disclosure will be described with reference to the attached drawings. In the attached drawings, functionally same elements may be denoted by the same numbers. Although the attached drawings illustrate specific embodiments and implementation examples according to the principles of the present disclosure, the drawings are intended to promote understanding of the present disclosure, and should never be used to interpret the technique of the present disclosure restrictively.

In the present embodiment, the description has been made in sufficient detail for those skilled in the art to implement the present disclosure. However, it is necessary to understand that other implementations and embodiments are possible, and changes in configurations and structures and replacement of various elements are possible without departing from the scope and spirit of the technical idea of the present disclosure. Therefore, the following description should not be interpreted as being limited thereto.

### <Configuration Example of Mass Spectrometer>

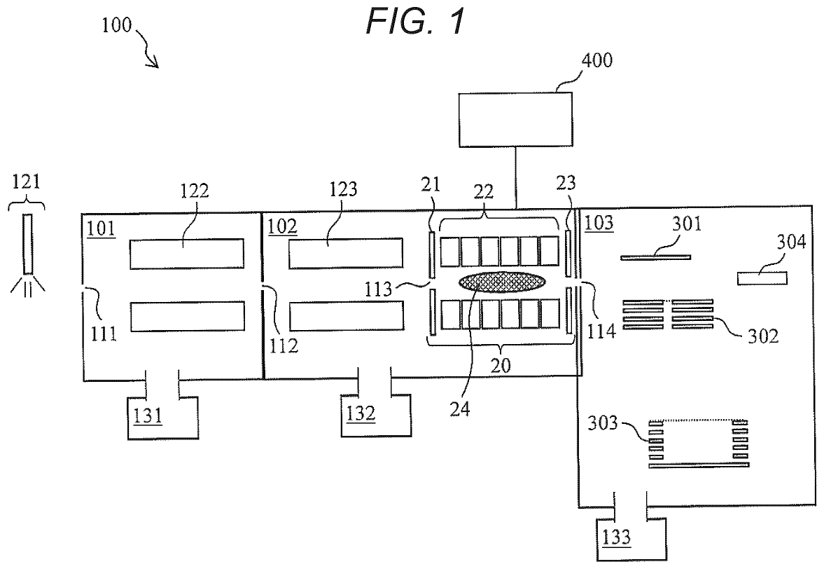

FIG. 1 is a view illustrating a configuration example of a mass spectrometer 100 which uses a linear ion trap according to the present embodiment. The mass spectrometer 100 includes an ion source 121, a differential pumping unit 101, an analyzer 102, a time-of-flight mass spectrometry unit 103, pumps 131 to 133, a computer 400 configured to manage and control the entire mass spectrometer, and a power source (not illustrated).

The ion source 121 may include, for example, an electrospray ionization ion source, an atmospheric chemical ionization ion source, an atmospheric pressure photoionization ion source, an atmospheric pressure matrix-assisted laser desorption/ionization ion source, a matrix-assisted laser desorption/ionization ion source, and the like.

Ions generated by the ion source 121 pass through an aperture 111 and are introduced into the differential pumping unit 101. The differential pumping unit 101 is pumped by the pump 131. The ions are introduced from the differential pumping unit 101 into the analyzer 102 through an aperture 112.

The analyzer 102 is pumped by the pump 132 to be maintained at 10⁻⁴ Torr or less (1.3×10⁻² Pa or less). The analyzer 102 includes an ion transport section 123 and the linear ion trap section 20. The ion transport section 123 may include an ion lens, a quadrupole filter, an ion trap, and the like. The ions having passed through the ion transport section 123 pass through an aperture 113 and are introduced into the linear ion trap section 20.

A buffer gas is introduced into the linear ion trap section 20 (not illustrated) and is maintained at 10⁻⁴ Torr to 10⁻² Torr (1.3×10⁻² Pa to 1.3 Pa). The linear ion trap section 20 includes an inlet-side end electrode 21, a multipole rod electrode 22, and an outlet-side end electrode 23. The ions introduced into the linear ion trap section 20 are trapped in a region (space) 24 surrounded by the inlet-side end electrode 21, the multipole rod electrode 22, and the outlet-side end electrode 23. The ions trapped in the region (space) 24 are mass selectively ejected in the axial direction by changing at least one of the amplitude of RF2 voltage or the amplitude of DC voltage.

The ions ejected from the linear ion trap section 20 pass through an aperture 114, and then are introduced into the time-of-flight mass spectrometry unit 103. The time-of-flight mass spectrometry unit 103 includes a push-out acceleration electrode 301, a pull-out acceleration electrode 302, a reflectron electrode 303, and a detector 304. The push-out acceleration electrode 301 accelerates the ions introduced into the time-of-flight mass spectrometry unit 103 in an orthogonal direction at a specific cycle, and then the pull-out acceleration electrode 302 accelerates the ions. Thereafter, the ions are reflected by the reflectron electrode 303, and detected by the detector 304 including a microchannel plate (MCP) or the like. Since the mass number can be obtained based on a time from the push-out acceleration to the detection, and the ion intensity can be obtained from the signal intensity, a mass spectrum can be obtained (the vertical axis represents the ion intensity; the horizontal axis represents the mass number).

For example, in response to an instruction input by an operator (user), the computer 400 controls values of RF1, RF2, and DC voltages to be applied to each rod electrode and each segment of the multipole rod electrode 22 in the linear ion trap section 20.

### <Details of Linear Ion Trap Section 20>

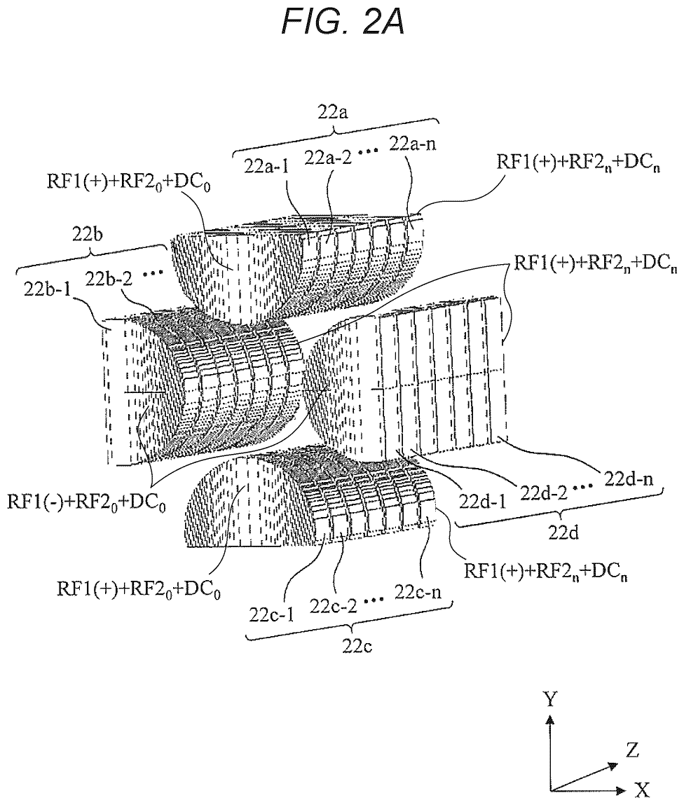

FIGS. 2A to 2C are views for explaining details of the linear ion trap section 20. FIG. 2A is a schematic view of appearance of the linear ion trap section 20 (multipole rod electrode 22). FIG. 2B is a view illustrating a configuration example of a radial cross section of the linear ion trap section 20 (multipole rod electrode 22). FIG. 2C is a view illustrating a configuration example of a radial cross section of the linear ion trap section 20 in the axial direction.

As can be seen from FIG. 2A, the multipole rod electrode 22 of the linear ion trap section 20 includes a plurality of, e.g., four, semi-cylindrical rod electrodes 22a to 22d. Each of the rod electrodes 22a to 22d includes a plurality of semi-cylindrical segments. The rod electrode 22a is comprised of segments 22a_1 to 22a_n, the rod electrode 22b is comprised of segments 22b_1 to 22b_n, the rod electrode 22c is comprised of segments 22c_1 to 22c_n, and the rod electrode 22d is comprised of segments 22d_1 to 22d_n. The segments may have a uniform height or different heights. In FIG. 2A illustrating the semi-cylindrical rod electrodes 22a to 22d, each of the rod electrodes 22a to 22d may have a cylindrical shape. As illustrated in FIGS. 2A and 2B, the semi-cylindrical or cylindrical rod electrodes 22a to 22d are equidistantly disposed from a linear ion trap center axis 29 in the region (space) 24 formed in the multipole rod electrode 22.

### <Control of Voltage Applied to Segment>

The computer 400 controls a first radio frequency (first high frequency) voltage (hereinafter referred to as an RF1 voltage) having an amplitude of 100 V to 5000 V and a frequency of about 500 kHz to 3 MHz to be applied to the multipole rod electrode 22 divided into a plurality of segments in the direction of the center axis of the linear ion trap section 20. At this time, RF1 voltages in phase are applied to the rod electrode 22a and the rod electrode 22c facing each other and the rod electrode 22b and the rod electrode 22d facing each other. Meanwhile, RF1 voltages in opposite phase are applied to the adjacent rod electrodes 22a and 22b, the adjacent rod electrodes 22b and 22c, the adjacent rod electrodes 22c and 22d, and the adjacent rod electrodes 22d and 22a. RF1 voltages in phase having the same amplitude are applied to all the segments of the rod electrode 22. The application of the RF1 voltages to the multipole rod electrode 22 results in generation of a pseudo potential which converges ions in the center axis direction orthogonal to the quadrupole rod axis direction (hereinafter defined as a radial direction). This is effective to give a radial distribution of ions which is within 1 to 2 mm from the center axis.

In the multipole rod electrode 22, a second radio frequency voltage in phase having the same amplitude (hereinafter referred to as an RF2 voltage) is superimposed on all of the divided segments of the rod electrodes 22a to 22d. The RF2 voltage may have, for example, an amplitude of 100 V to 5000 V and a frequency of 500 kHz to 3 MHz.

Further, the same electrostatic voltage (hereinafter, segment DC) is superimposed on the segments (e.g., segments 22a_k to 22d_k; k=an integer from 1 to n) at the same position in each of the rod electrodes 22a to 22d (however, the electrostatic voltage applied to the segments 22a_k to 22d_k is different from the electrostatic voltage applied to the segments 22a_k+1 to 22d_k+1).

In the present embodiment, under the control of the computer 400, the amplitude of RF2 applied to each of the segments or the segment DC is increased or decreased according to the position in the center axis direction of the linear ion trap section 20, and thus a potential for trapping ions is formed on the center axis 29 of the linear ion trap section 20 as shown in FIG. 2C.

### <Application of DC Voltage and RF2 Voltage to Each Segment>

In the linear ion trap section 20, the DC voltage is applied to each of the segments (segments 22a_1 to 22a_n, segments 22b_1 to 22b_n, segments 22c_1 to 22c_n, and segments 22d_1 to 22d_n) such that the DC voltage decreases as the segment number increases (1→n), whereas the RF2 voltage is applied to each of the segments such that the RF2 voltage increases as the segment number increases (1→n). Note that the DC voltage and the RF2 voltage are not necessarily applied so as to be linearly small or large.

As an example, the segment DC voltage for each of the segments is applied as in the following equation (1):

DCₙ=DC0−ΔDC×n (1)

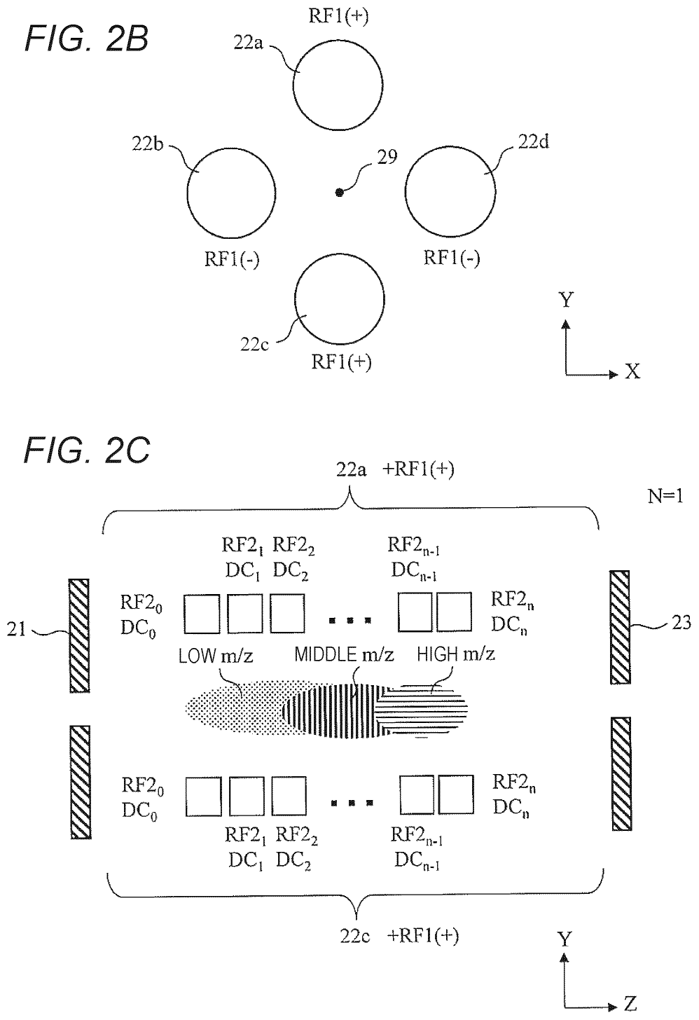

Here, DCₙ is the DC voltage applied to the nth segment and ΔDC is the segment DC voltage difference between adjacent segments. The potential formed on the center axis by the segment DC is as shown in FIG. 3.

In addition, the RF2 voltage for each of the segments (1→n) is applied as in the following equation (2):

RF2ₙ=RF2₀+ΔRF×n² (2)

Here, RF2ₙ is the RF2 voltage amplitude of the nth segment and ΔRF is the RF2 voltage amplitude difference between adjacent segments.

The pseudo potential Ψ of a monovalent ion formed by the RF2 voltage is expressed by the following equation (3):

Ψ=(e×E2)/(4×m×Ω2) (3)

Here, e represents elementary electric charge, m represents ion mass, Ω represents each frequency of RF voltage, and E represents electric field intensity amplitude formed by RF voltage. It will be seen from equation (3) that the pseudo potential Ψ formed by the RF field is in inverse proportion to the ion mass.

Meanwhile, when the axial length of the segment is sufficiently small with respect to the radial radius of the linear ion trap section 20, it is possible to obtain form equation (3) the pseudo potential formed on the center axis when the RF2 voltage of equation (2) is applied.

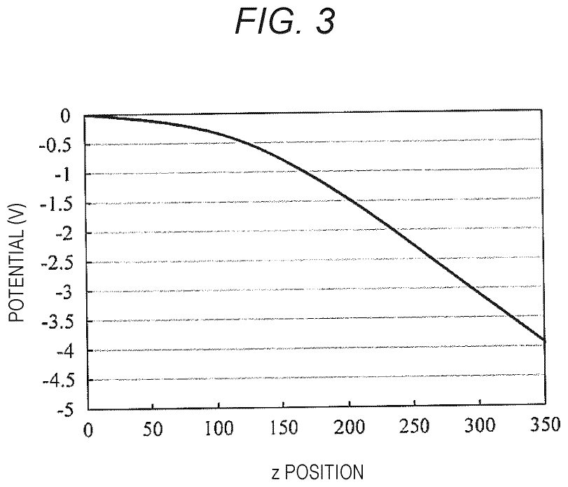

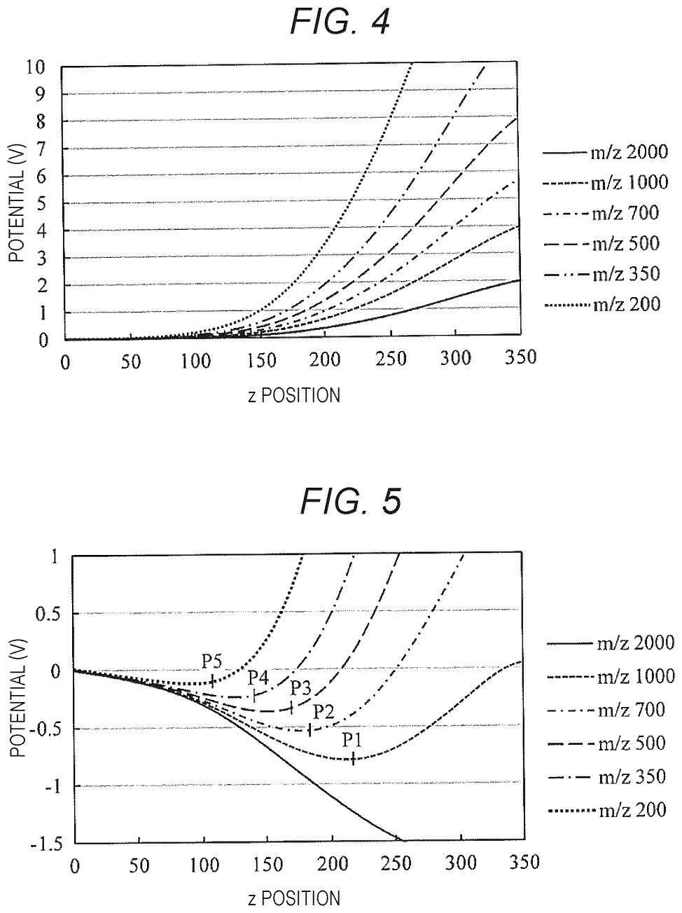

FIG. 4 is a graph showing a pseudo potential formed on the center axis when RF2 voltage of equation (2) is applied. Further, FIG. 5 is a diagram showing a combined potential formed by combining the potential of segment DC in FIG. 3 with the pseudo potential of RF2 in FIG. 4. Referring to FIG. 5, it can be seen that the position of the minimum point of the combined potential on the center axis 29 depends on m/z. This makes it possible to disperse ions on the entire center axis and trap the dispersed ions, and the influence of space charge is much less likely to be received as compared with a known method of trapping ions only on a part of the center axis.

In the present embodiment, an example has been described in which the segment DC voltage is applied to each of the segments as shown in equation (1) and the RF2 voltage is applied to each of the segments as shown in equation (2). In general, for example, the segment DC voltage is monotonously decreased from the inlet side to the outlet side of the linear ion trap, and a DC potential to pull out ions to the outlet side is formed on the center axis of the linear ion trap. For example, the RF2 voltage is monotonously increased from the inlet side to the outlet side of the linear ion trap, and a pseudo potential to push out ions to the inlet side is formed on the center axis 29 of the linear ion trap section 20. This configuration makes it possible to realize a linear ion trap in which ions are dispersed on the center axis 29 and the space charge effect is less likely to be received. Meanwhile, as described above, the segment DC voltage does not necessarily decrease linearly, and the RF2 voltage does not necessarily increase linearly.

### <Ejection of Ions>

### (i) Sequence

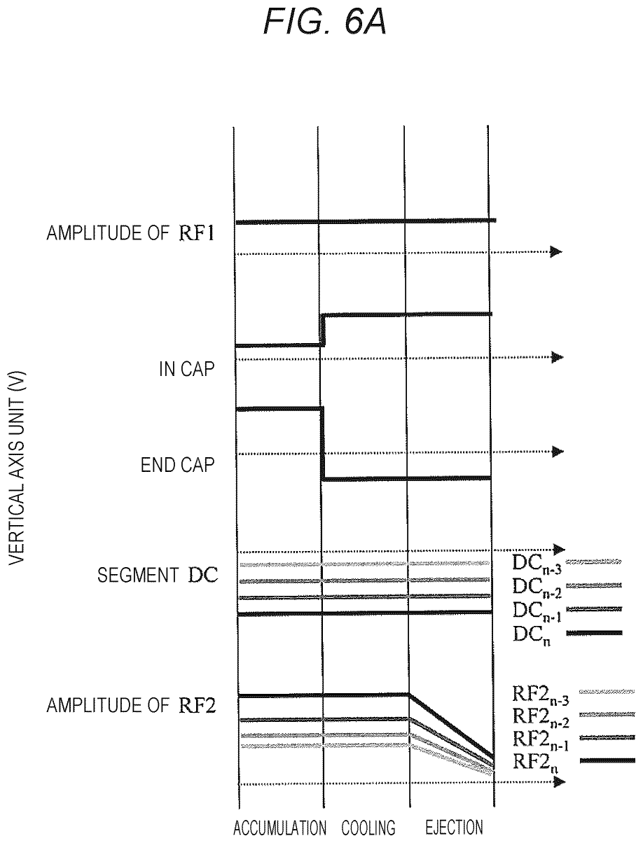

Typical voltages applied when positive ions are ejected from the linear ion trap section 20 will be described. FIGS. 6A and 6B are diagrams each showing a sequence from accumulation of ions to ejection of ions. The method of ejecting ions includes, for example, a method of scanning (changing) RF2 and a method of scanning (changing) segment DC voltage. FIG. 6A is a diagram showing a sequence when ions are accumulated and cooled, and RF2 is scanned (changed) to eject the ions. FIG. 6B is a diagram showing a sequence when ions are accumulated and cooled, and segment DC voltage is scanned (changed) to eject the ions.

As shown in FIGS. 6A and 6B, the process from the start to the ejection of ions is performed in three sequences (accumulation→cooling→ejection). FIGS. 6A and 6B show, as an example, only the segment DC voltages (DCₙ to DCₙ₋₃) and the RF2 voltages (RF2ₙ to RF2ₙ₋₃) applied to the nth to n-3rd segments.

During ion accumulation time, the computer 400 sets the inlet-side end electrode to 0 V and sets the outlet-side end electrode to 20 V (only DC voltage). Further, the computer 400 controls the segment DC voltage to be applied as shown in equation (1), and controls the RF2 voltage to be applied as shown in equation (2). A pseudo potential is generated radially of a quadrupole field by the RF1 voltage, and a DC potential is generated toward the outlet end in the direction of the center axis of the quadrupole field. Thus, various ions (m/z=200 to 2000) having passed through the aperture 113 are trapped at the minimum points (P1 to P5) of the combined potential in FIG. 5. The length of trapping time is about 1 ms to 1000 ms.

During the cooling time, the computer 400 sets the voltage of the inlet-side end electrode to a range of 0 to 100 V (20 V as an example), and prevents ions from being introduced into the linear ion trap section 20.

Moreover, during the ejection time, the computer 400 allows, for example, the voltage of the outlet-side end electrode 23 to be changed from about +20 V to 0 V. Thus, only ions near the end portion are ejected in the axial direction. The computer 400 allows the gradient (ΔRF2) of the amplitude of RF2 voltage for each segment in equation (2) to be scanned from high to low (changed in proportion to time) (see FIG. 6A). Alternatively, the computer 400 allows the gradient (ΔDC) of the segment DC voltage to be scanned from high to low (see FIG. 6B). Alternatively, the computer 400 may allow both the ΔRF2 and the ΔDC to be scanned. Consequently, the potential minimum points (P1 to P5) are sequentially moved toward the outlet end, in order of ions of high m/z, and mass selective ejection is carried out in the axial direction.

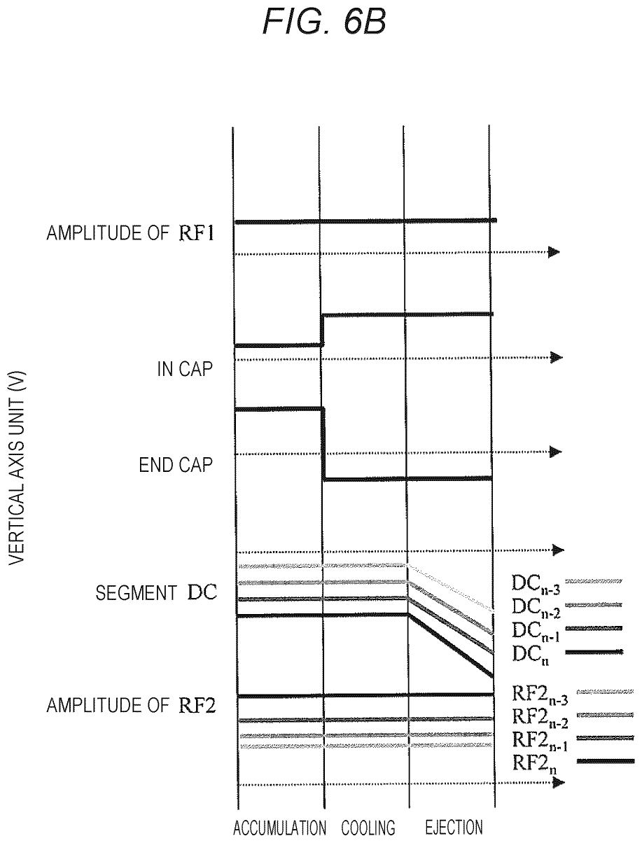

FIG. 7 is a diagram showing a potential of ions of m/z 200 when an amplitude of RF2 is scanned from 74 V to 22 V. In FIG. 7, as the RF2 voltage decreases, the potential minimum point is moved to the vicinity of the outlet end. When the voltage is 31 V, ions are ejected from the linear ion trap section 20. At the time when ions with a specified m/z are ejected, ions with a larger m/z than that of the ions have already been ejected, and ions with a smaller m/z than that of the ions have been trapped on the inlet end side of the linear ion trap section 20. Thus, the influence of space charge is less likely to be received during ejection of ions.

Meanwhile, although the measurement of positive ions has been described above, the polarities of all DC voltages may be reversed at the time of measuring negative ions.

(ii) Comparison with Method Based on Resonant Excitation

In the present embodiment, unlike the known ejection method based on resonant excitation, ions are sequentially ejected from the vicinity of the minimum point of the potential, and the energy distribution can be minimized. This feature facilitates the subsequent convergence by the lens. Therefore, this assures highly efficient introduction of ions to a time-of-flight mass spectrometer with high mass resolution, an electric field Fourier transform mass spectrometer (such as an orbitrap mass spectrometer), or a Fourier transform ion cyclotron resonance mass spectrometer.

(iii) Combination of Linear Ion Trap and Orthogonal Time-of-Flight Mass Spectrometer

A combination of the linear ion trap according to the present embodiment and an orthogonal time-of-flight mass spectrometer will be described.

The orthogonal time-of-flight mass spectrometer has excellent performance including high mass resolution. However, the trade-off relation stands between the sensitivity and the detection range on the high mass side. In other words, in measuring ions on the high mass side, the detection efficiency on the low mass side is degraded.

Therefore, the linear ion trap according to the present embodiment is used in the orthogonal time-of-flight mass spectrometer, so that a shorter measurement period can be used during measurement of ions on the low mass side while a longer measurement period can be used for measurement of ions on the high mass side. Specifically, the accelerating period can be changed within a width of, for example, about 30 to 300 us depending on the mass. Thus, in the overall mass range, ion detection with high efficiency and high resolution can be achieved.

### <Modified Example>

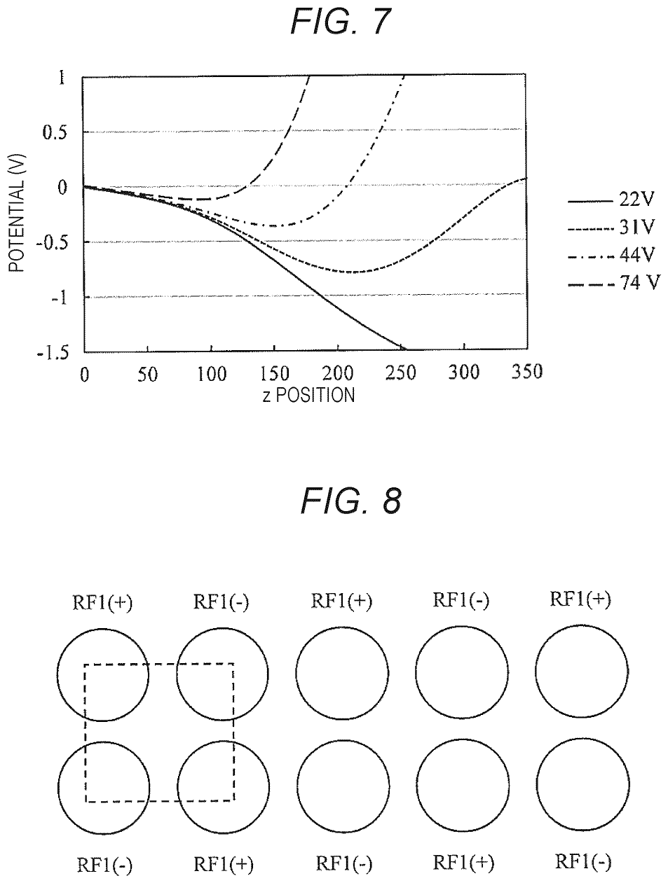

FIG. 8 is a view illustrating a configuration example of a radial cross section of a linear ion trap section 20′ according to a modified example. In FIG. 8, a portion 80 surrounded by a dotted square corresponds to the linear ion trap section 20 in FIGS. 2A to 2C. In other words, the linear ion trap section 20′ includes a plurality of linear ion trap sections 20. However, in the configuration corresponding to the adjacent linear ion trap sections 20, the rod electrode is shared (commonized).

According to the modified example, the rod electrode is shared between the adjacent linear ion traps, and thus parallelization can be achieved with a small number of components. Further, in the modified example, the arrangement of the linear ion traps in parallel enables ions to be widely dispersed in the region (space) formed between the multipole rod electrodes, as a result of which the influence of space charge is much less likely to be received as compared with the case of adopting the linear ion trap section 20 in FIGS. 2A to 2C. Accordingly, even when a large number of ions are introduced into the linear ion trap section 20′, the performance of selectively ejecting ions can be maintained. However, the configuration becomes complicated as compared with the linear ion trap section 20 shown in FIGS. 2A to 2C, leading to high production costs. Therefore, the configuration of the linear ion trap section 20′ can be determined by the trade-off between the production cost and the ion dispersion effect.

### <Conclusion>

(i) In the mass spectrometer according to the present embodiment, in the multipole rod electrode 22, the first radio frequency voltage in opposite phase (RF1 voltage) is applied to the adjacent rod electrodes (22a to 22d), and the electrostatic voltage (DC voltage) having the same amplitude and the second radio frequency voltage (RF2 voltage) are applied to the segments (e.g., segments 22a_1 and 22b_1) located at the same position in the direction of the center axis 29 of the linear ion trap section 20, the second radio frequency voltage being different from the first radio frequency voltage and being in phase. Further, the electrostatic voltage (DC voltage) is applied to the plurality of segments such that the electrostatic voltage decreases from the inlet side (segment on the inlet-side end electrode 21 side) to the outlet side (segment on the outlet-side end electrode 23 side) of the linear ion trap section 20 (see equation (1)). The second radio frequency voltage (RF2 voltage) is applied to the plurality of segments such that the second radio frequency voltage increases from the inlet side (segment on the inlet-side end electrode 21 side) to the outlet side (segment on the outlet-side end electrode 23 side) of the linear ion trap section 20 (see equation (2)). Since the DC voltage and the RF2 voltage are applied to each of the segments in the above-described manner, it is possible to trap ions in the region (space) 24 formed by the multipole rod electrode, in descending order of mass to charge ratio m/z. Specifically, the linear ion trap section 20 traps ions at a position (e.g., P1 to P5) indicating a minimum of combined characteristics (see FIG. 5) obtained by combining characteristics (see FIG. 3) of the electrostatic voltage (DC voltage) with respect to the position in the direction of the center axis 29 and characteristics (see FIG. 4) of the second radio frequency voltage (RF2 voltage) with respect to the position in the direction of the center axis 29.

(ii) The linear ion trap section 20 scans the gradient (ΔDC) of the electrostatic voltage from high to low, or scans the gradient (ΔRF2) of the second radio frequency voltage (RF2 voltage) from high to low (see FIGS. 6A and 6B), in order to mass selectively eject ions to the analyzer (time-of-flight mass spectrometry unit 103). The execution of such voltage scanning allows ions to be ejected to the analyzer in descending order of m/z without loss.

(iii) The modified example of the linear ion trap section 20 (linear ion trap section 20′) has a configuration in which a plurality of linear ion trap sections 20 is arranged in parallel. In this case, the adjacent linear ion trap sections share some multipole rod electrodes (see FIG. 8). Due to the use of the linear ion trap section 20′ having such a configuration, it is possible to disperse ions emitted from the ion source 121 in a plurality of regions (spaces) formed by the plurality of linear ion trap sections and to trap the dispersed ions. Therefore, it is possible to expect an effect that the influence of space charge is much less likely to be received.

What is claimed is:

1. A mass spectrometer comprising:
a linear ion trap section that traps ions emitted from an ion source; and
an analyzer that analyzes the ions ejected from the linear ion trap section, wherein
the linear ion trap section includes a multipole rod electrode that forms a multipole electric field, the multipole rod electrode including a plurality of segments arranged in a direction of a center axis of the linear ion trap section,
in the multipole rod electrode, a first radio frequency voltage in opposite phase is applied to adjacent rod electrodes,
an electrostatic voltage having a same amplitude and a second radio frequency voltage are applied to the segments having a same position in the direction of the center axis, the second radio frequency voltage being different from the first radio frequency voltage and being in phase,
the electrostatic voltage is applied to the plurality of segments such that the electrostatic voltage decreases from an inlet to an outlet of the linear ion trap section, and
the second radio frequency voltage is applied to the plurality of segments such that the second radio frequency voltage increases from the inlet to the outlet of the linear ion trap section.

2. The mass spectrometer according to claim 1, wherein
the linear ion trap section traps the ions in a region formed by the multipole rod electrode, in descending order of mass to charge ratio m/z.

3. The mass spectrometer according to claim 2, wherein
the linear ion trap section traps the ions at a position indicating a minimum of combined characteristics obtained by combining characteristics of the electrostatic voltage with respect to the position in the direction of the center axis and characteristics of the second radio frequency voltage with respect to the position in the direction of the center axis.

4. The mass spectrometer according to claim 2, wherein
the linear ion trap section scans a gradient of the electrostatic voltage from high to low, to cause the ions to be mass selectively ejected from the linear ion trap section to the analyzer.

5. The mass spectrometer according to claim 2, wherein
the linear ion trap section scans a gradient of the second radio frequency voltage from high to low, to cause the ions to be mass selectively ejected from the linear ion trap section to the analyzer.

6. The mass spectrometer according to claim 1, further comprising a plurality of the linear ion trap sections connected in parallel, wherein
the adjacent linear ion trap sections share some of the multipole rod electrodes, and
the ions are dispersed in a plurality of regions formed by the plurality of linear ion trap sections, and the dispersed ions are trapped.

7. A mass spectrometry method comprising:
emitting ions from an ion source;
applying a first radio frequency voltage in opposite phase to adjacent rod electrodes in a multipole rod electrode that forms a multipole electric field in a linear ion trap section, the multipole rod electrode including a plurality of segments arranged in a direction of a center axis of the linear ion trap section;
applying an electrostatic voltage having a same amplitude and a second radio frequency voltage to the segments having a same position in the direction of the center axis, the second radio frequency voltage being different from the first radio frequency voltage and being in phase; and
ejecting the ions from the linear ion trap section to an analyzer, wherein
the electrostatic voltage is applied to the plurality of segments such that the electrostatic voltage decreases from an inlet to an outlet of the linear ion trap section, and
the second radio frequency voltage is applied to the plurality of segments such that the second radio frequency voltage increases from the inlet to the outlet of the linear ion trap section.

8. The mass spectrometry method according to claim 7, further comprising trapping, in the linear ion trap section, the ions in a region formed by the multipole rod electrode, in descending order of mass to charge ratio m/z.

9. The mass spectrometry method according to claim 8, wherein
the linear ion trap section traps the ions at a position indicating a minimum of combined characteristics obtained by combining characteristics of the electrostatic voltage with respect to the position in the direction of the center axis and characteristics of the second radio frequency voltage with respect to the position in the direction of the center axis.

10. The mass spectrometry method according to claim 8, further comprising scanning, in the linear ion trap section, a gradient of the electrostatic voltage from high to low, to mass selectively eject the ions from the linear ion trap section to the analyzer.

11. The mass spectrometry method according to claim 8, further comprising scanning, in the linear ion trap section, a gradient of the second radio frequency voltage from high to low, to mass selectively eject the ions from the linear ion trap section to the analyzer.

12. The mass spectrometry method according to claim 7, further comprising:
providing a plurality of linear ion trap sections which are connected in parallel wherein adjacent linear ion trap sections of the plurality of linear ion trap sections share some of the multipole rod electrodes, and
dispersing the ions in a plurality of regions formed by the plurality of linear ion trap sections to trap the dispersed ions.
